(19) United States
(12) Patent Application Publication
(10) Pub. No.: US 2025/0392982 A1
(43) Pub. Date: Dec. 25, 2025

(54) ACCESS POINT AND METHOD FOR ESTABLISHING A CANDIDATE WIRELESS ACCESS POINTS LIST

(71) Applicant: EMPLUS TECHNOLOGIES, INC., Taipei (TW)

(72) Inventor: Cheng Hsiung LIN, Taipei (TW)

(21) Appl. No.: 18/962,297

(22) Filed: Nov. 27, 2024

(30) Foreign Application Priority Data
Jun. 24, 2024 (TW) 113123304

(51) Int. Cl. H04W 48/16

(52) U.S. Cl. CPC H04W 48/16

(57) ABSTRACT

An access point and a method for establishing a candidate wireless access points list are provided. The access point includes a transceiver and a processor, wherein the processor is electrically connected with the transceiver. The transceiver is configured to receive a wireless access points message or a plurality of wireless access points messages transmitted by a remote wireless access point or a plurality of remote wireless access points, respectively. The processor is configured to generate a candidate wireless access points list based on the wireless access points message or the plurality of wireless access points messages. The transceiver is also configured to execute channel scanning based on the candidate wireless access points list, and the processor is also configured to generate a neighbor wireless access points list based on a result of the channel scanning.

### CROSS-REFERENCES TO RELATED APPLICATIONS

This application claims priority to Taiwan Patent Application No. 113123304 filed on Jun. 24, 2024, the entire contents of which are incorporated herein by reference.

### BACKGROUND OF THE INVENTION

### Field of the Invention

The present invention relates to an access point and a method for establishing a candidate wireless access points list. More specifically, the present invention relates to an access point which generates a candidate wireless access points list by communicating with other remote wireless access points and a method for establishing a candidate wireless access points list.

### Descriptions of the Related Art

In the conventional wireless network roaming technology, when a mobile device is connected to an access point (AP), the mobile device may send a request, which is also referred to as a neighbor report request, to the connected access point according to the IEEE 802.11k standard. After receiving the neighbor report request, the access point will transmit a response, which is also referred to as a neighbor report response, to the mobile device, so that the mobile device can acquire information of other available neighbor wireless access points.

Because the way to acquire the information of other wireless access points available for roaming is not explicitly defined in the IEEE 802.11k standard, the access point cannot provide an effective candidate wireless access points list or a neighbor report response to the mobile device. Therefore, the mobile device still has to perform full-channel scanning on neighbor wireless access points in order to acquire information of neighbor wireless access points available for roaming, which results in a large amount of extra time and power consumption and makes it difficult to rapidly find out suitable neighbor wireless access points that can provide successful networking. Accordingly, an urgent need exists in the art to improve the aforesaid problems of wireless network roaming in the conventional access points.

### SUMMARY OF THE INVENTION

In order to solve at least the above problems, an embodiment of the present invention provides an access point. The access point may include a transceiver and a processor. The processor is electrically connected with the transceiver. The transceiver is configured to receive a wireless access points message or a plurality of wireless access points messages transmitted by a remote wireless access point or a plurality of remote wireless access points, respectively. The processor is configured to generate a candidate wireless access points list based on the wireless access points message or the plurality of wireless access points messages.

The transceiver is further configured to perform channel scanning based on the candidate wireless access points list, and the processor is further configured to generate a neighbor wireless access points list based on a result of the channel scanning.

In order to solve at least the above problems, an embodiment of the present invention further provides a method for establishing a candidate wireless access points list. The method for establishing the candidate wireless access points list may include the following steps: receiving, by an access point, a wireless access points message or a plurality of wireless access points messages transmitted by a remote wireless access point or a plurality of remote wireless access points respectively; and generating, by the access point, a candidate wireless access points list based on the wireless access points message or the plurality of wireless access points messages.

In order to solve at least the above problems, an embodiment of the present invention further provides a method for establishing a neighbor wireless access points list. The method for establishing the neighbor wireless access points list may include the following steps: receiving, by an access point, a wireless access points message or a plurality of wireless access points messages transmitted by a remote wireless access point or a plurality of remote wireless access points respectively; and generating, by the access point, a candidate wireless access points list based on the wireless access points message or the plurality of wireless access points messages; performing channel scanning based on the candidate wireless access points list by the access point; and generating a neighbor wireless access points list based on a result of the channel scanning by the access point.

As mentioned above, the present invention includes at least the above access point and the method for establishing a candidate wireless access points list, through which a wireless access points message or a plurality of wireless access points messages transmitted by a remote wireless access point or a plurality of remote wireless access points can be received to generate a candidate wireless access points list.

Therefore, the candidate wireless access points list generated in the present invention has already included information of other candidate wireless access points that can be connected successfully. Specifically, a mobile device can send a neighbor report request to the access point, then the access point generates a candidate wireless access points list based on the wireless access points message or the plurality of wireless access points messages, takes the candidate wireless access points list as the neighbor report response, and transmits the neighbor report response to the mobile device. In this way, the mobile device can rapidly find out suitable access points that can be connected successfully based on the candidate wireless access points list without performing channel scanning on all neighbor wireless access points, which can effectively save the time and power consumed by the mobile device to perform channel scanning on the neighbor wireless access points. Therefore, the access point and the method for establishing a wireless access points list provided according to the present invention effectively solve the above problems of the conventional wireless network roaming technology.

Moreover, the present invention further includes the above access point and the method for establishing a neighbor wireless access points list, through which a wireless access points message or a plurality of wireless access points messages transmitted by a remote wireless access point or a plurality of remote wireless access points can be received to generate the candidate wireless access points list. Further, channel scanning is performed according to the candidate wireless access points list, then a neighbor wireless access points list is generated based on a result of the channel scanning, and the neighbor wireless access points list is transmitted to the mobile device as the neighbor report response. In this way, the mobile device only needs to perform channel scanning on wireless access points within the neighbor wireless access points list instead of performing full-channel scanning on other access points.

What described above are not intended to limit the present invention, but only generally describe the technical problems that can be solved by the present invention, the technical means that can be adopted by the present invention and the technical effects that can be achieved by the present invention so as to provide preliminary appreciation of the present invention by those of ordinary skill in the art. According to the attached drawings and the contents described in the following embodiments, those of ordinary skill in the art can further appreciate the details of various embodiments of the present invention.

### BRIEF DESCRIPTION OF THE DRAWINGS

FIG. 1A illustrates a schematic architecture view of an access point according to some embodiments of the present invention.

FIG. 1B illustrates a schematic architecture view of an access point according to another embodiment of the present invention.

FIG. 2A is a schematic view illustrating how to generate a candidate wireless access points list by an access point according to some embodiments of the present invention.

FIG. 2B is a schematic view illustrating how to generate a neighbor wireless access points list by an access point according to some embodiments of the present invention.

FIG. 3 illustrates a flowchart diagram of a method for establishing a neighbor wireless access points list according to some embodiments of the present invention.

### DESCRIPTION OF THE PREFERRED EMBODIMENT

Hereinafter, the present invention will be described with reference to a number of embodiments. However, these embodiments are not intended to limit the present invention to be implemented only according to operations, environment, applications, structures, flow processes or steps described herein. Elements unrelated to the present invention are omitted from depiction, but may be implied in the attached drawings. In the attached drawings, dimensions of and dimensional scales among individual elements are provided only for illustration, and are not intended to limit the present invention. Unless otherwise specified, in the following description, the same (or similar) reference numerals may correspond to the same (or similar) elements. Unless otherwise specified, the number of respective elements described below may be one or more while being implementable.

Terms used in the present invention are only for describing the embodiments and are not intended to limit the present invention. Unless clearly indicated otherwise in the context, the singular form “a/an/one” is intended to include the plural form as well. Terms such as “including” and “comprising” indicate the presence of features, integers, steps, operations, elements and/or components described herein, but do not exclude the presence of one or more other features, integers, steps, operations, elements, components and/or combinations thereof. The term “and/or” includes any and all combinations of one or more related items listed.

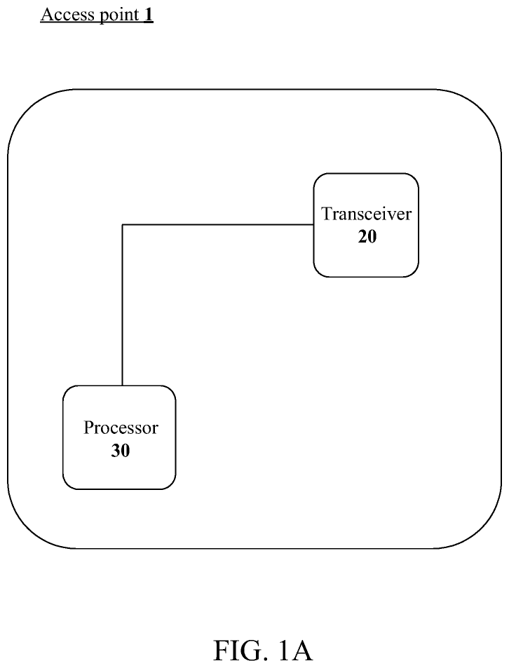

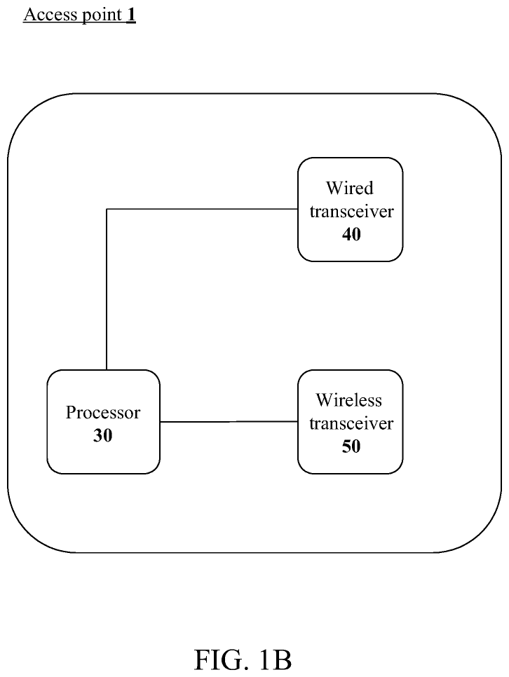

FIG. 1A illustrates a schematic architecture view of an access point according to some embodiments of the present invention. The content shown in FIG. 1A is only for illustrating some embodiments of the present invention, and is not intended to limit the scope claimed in the present invention.

Referring to FIG. 1A, in some embodiments of the present invention, an access point 1 may basically include a transceiver 20 and a processor 30 with the processor 30 and the transceiver 20 electrically connected (directly or indirectly) to each other. The transceiver 20 is configured to transmit a wireless access points message to a remote wireless access point or a plurality of wireless access points respectively, and receive a wireless access points message or a plurality of wireless access points messages transmitted by the remote wireless access point or the plurality of remote wireless access points respectively. Specifically, the access point 1 may communicate with a remote wireless access point or a plurality of remote wireless access points by broadcasting, so as to realize mutual transmission of access points messages therebetween. Remote wireless access points refer to other access points that can communicate with the access point 1 but have not been connected to a mobile device. In addition, when the access point 1 is connected with the mobile device (i.e., the mobile device is within the available signal coverage of the access point 1), the mobile device may send a request (i.e., a neighbor report request) to the access point 1, and after the request is received by the access point 1, the access point 1 may transmit a response (i.e., neighbor report response) to the mobile device.

Referring to FIG. 1B, in some embodiments, the access point 1 may include a wired transceiver 40 and a wireless transceiver 50, or only include a wireless transceiver 50 or a plurality of wireless transceivers 50 (not shown). It should be noted that, the number and types of transceivers are not limited in the present invention.

The access point 1 and the remote wireless access point or the plurality of remote wireless access points all have their Service Set Identifier (SSID) information, wireless network security settings and their wireless channel setting information. For example, the SSID is the identification name of the access point 1, the SSID information includes a Basic Service Set Identifier (BSSID) and an Extended Service Set Identifier (ESSID), the wireless network security setting is the security types and network security key of the access point 1, and the wireless channel setting information is the setting of the channel number and wireless frequency used by the access point 1, without being limited thereto.

In some embodiments, the transceiver 20 may be configured to respectively transmit the wireless access points message to the remote wireless access point or the plurality of remote wireless access points periodically or aperiodically, and respectively receive the wireless access points message or the plurality of wireless access points messages transmitted by a remote wireless access point or a plurality of remote wireless access points. Whether the wireless access points message is transmitted to the remote wireless access point or the plurality of remote wireless access points periodically or aperiodically is not limited in the present invention, and thus this will not be further described herein. In some embodiments, the remote wireless access point or the plurality of remote wireless access points may also actively transmit the wireless access points message or the plurality of wireless access points messages to the access point 1, respectively.

Accordingly, the processor 30 may generate a candidate wireless access points list SL (referred to as a candidate list SL hereinafter) based on the wireless access points message or the plurality of wireless access points messages. Then, when the request sent by the mobile device is received by the access point 1, the access point 1 may transmit the candidate list SL to the mobile device as a response, so that the mobile device can be connected according to the candidate list SL.

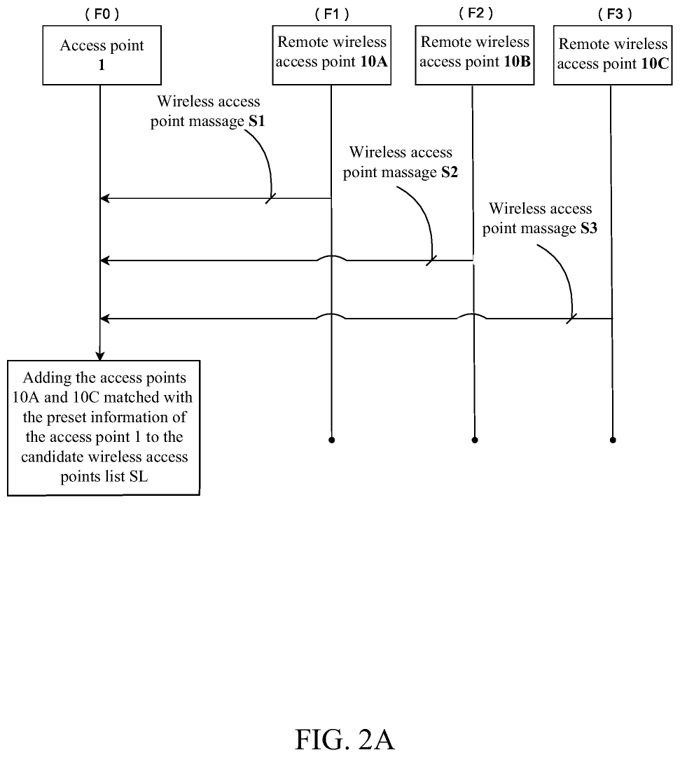

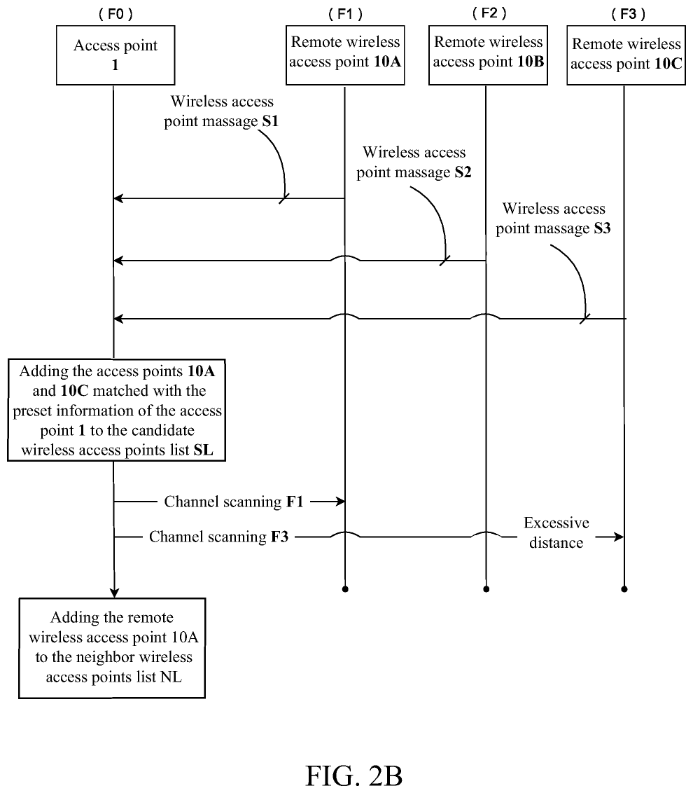

FIG. 2A is a schematic view illustrating how to generate a candidate wireless access points list by an access point according to some embodiments of the present invention. The content shown in FIG. 2A is only for illustrating some embodiments of the present invention, and is not intended to limit the scope claimed in the present invention.

Referring to FIG. 2A, for example, the transceiver 20 of the access point 1 receives a wireless access points message S1 (referred to as a message S1 hereinafter), a wireless access points message S2 (referred to as a message S2 hereinafter) and a wireless access points message S3 (referred to as a message S3 hereinafter) transmitted by a remote wireless access point 10A, a remote wireless access point 10B and a remote wireless access point 10C, respectively. The channel of the access point 1 is F0, the channel of the remote wireless access point 10A is F1, the channel of the remote wireless access point 10B is F2, and the channel of the remote wireless access point 10C is F3.

After the transceiver 20 of the access point 1 receives the message S1, the message S2 and the message S3, the processor 30 is configured to generate a candidate list SL based on the message S1, the message S2 and the message S3. Specifically, the processor 30 may analyze the message S1, the message S2 and the message S3 to determine whether information (such as the above-mentioned SSID, wireless network security settings, etc.) in the message S1, the message S2 and the message S3 matches with a preset information (such as the above-mentioned SSID, security settings, etc.) of the access point 1. For example, if the information included in the message S1 and the message S3 matches with the preset information of the access point 1, while the information in the message S2 does not match with the preset information of the access point 1, then the processor 30 will generate a candidate list SL based on the message S1, the message S2 and the message S3. Then, when the access point 1 receives the request sent by the mobile device, the access point 1 may transmit the candidate list SL to the mobile device as a response, so that the mobile device can be connected based on the candidate list SL. In this case, the candidate list SL of the access point 1 includes the remote wireless access point 10A and the remote wireless access point 10C and does not include the remote wireless access point 10B.

It should be additionally noted that, the candidate list SL includes the preset information of the remote wireless access point 10A and the preset information of the remote wireless access point 10C, so the mobile device can perform channel scanning based on the candidate list SL without performing channel scanning on all the remote wireless access points. Therefore, the mobile device can effectively save the time and power consumed by the channel scanning through the candidate list SL generated by the access point 1.

Next referring to FIG. 2B, in some embodiments, after generating the candidate list SL, the access point 1 does not firstly transmit the candidate list SL to the mobile device. Instead, the transceiver 20 the access point 1 directly performs channel scanning based on the candidate list SL (i.e., performs scanning on the channel F1 of the remote wireless access point 10A and the channel F3 of the remote wireless access point 10C). Then, the processor 30 obtains a scanning result, which may include the SSIDs of these remote wireless access points, based on the remote wireless access point 10A and the remote wireless access point 10C. The processor 30 may identify whether the message acquired by the channel scanning is from the remote wireless access point 10A or the remote wireless access point 10C. Moreover, the scanning result may also indicate whether these remote wireless access points are in the vicinity of the access point 1 or whether these remote wireless access points are within the available signal coverage, or even indicate the range in which the signal strength of the remote wireless access points can still be read, and a neighbor list NL is generated based on the scanning result. Then, when the request sent by the mobile device is received by the access point 1, the access point 1 may transmit the neighbor list NL to the mobile device as a response, so that the mobile device can be connected based on the neighbor list NL. In this case, whether the remote wireless access point 10A and the remote wireless access point 10C are in the vicinity of the access point 1 can be confirmed.

Specifically, the processor 30 may confirm whether the remote wireless access point 10A and the remote wireless access point 10C are within a preset distance (e.g., a distance within which messages can be received or transmitted by the transceiver 20). For example, if the remote wireless access point 10A is within the preset distance (that is, within the range where messages can be received or transmitted by the transceiver 20), and the remote wireless access point 10C is out of the preset distance (that is, out of the range where messages can be received or transmitted by the transceiver 20), then when the access point 1 performs scanning on the channel F1 of the remote wireless access point 10A and the channel F3 of the remote wireless access point 10C, the remote wireless access point 10A will respond to the access point 1, while the remote wireless access point 10C will not response to the access point 1. In other words, a scanning response including the SSID of the remote wireless access point 10A will be received by the access point 1, while a scanning response including the SSID of the remote wireless access point 10C will not be received. The processor 30 will generate a neighbor list NL based on a result of the channel scanning. In this case, the neighbor list NL includes the remote wireless access point 10A but does not include the remote wireless access point 10C.

In some embodiments, both the remote wireless access points 10A and 10C are within the preset distance, but the remote wireless access point 10A is closer to the access point 1 while the remote wireless access point 10C is farther away from the access point 1. In this case, when the access point 1 performs scanning on the channel F1 of the remote wireless access point 10A and the channel F3 of the remote wireless access point 10C, the response signal of the remote wireless access point 10A is stronger, while the response signal of the remote wireless access point 10C is weaker. Then, the processor 30 of the access point 1 may sort the remote wireless access points 10A and 10C in the order of strength of response signals thereof, and generate the neighbor list NL accordingly.

In some embodiments, after the candidate list SL is generated and after the access point 1 is connected with the mobile device, the access point 1 may transmit the candidate list SL to the mobile device as a response even if the access point 1 has not received the request of the mobile device, so that the mobile device can be connected based on the candidate list SL. Then, after the request of the mobile device is received by the access point 1, the transceiver 20 of the access point 1 may be configured to perform channel scanning based on the candidate list SL, so as to confirm whether the remote wireless access point 10A and the remote wireless access point 10C are in the vicinity of the access point 1 or within the available signal coverage. Thereafter, the processor 30 generates a neighbor list NL based on a result of the channel scanning, so that the access point 1 can transmit the neighbor list NL as a response to the mobile device. In other words, after the request of the mobile device is received by the access point 1, the access point 1 performs channel scanning based on the candidate list SL so as to generate the neighbor list NL. Then, the access point 1 also transmits the neighbor list NL to the mobile device as a response, so that the mobile device can be connected based on the neighbor list NL instead of the candidate list.

In some embodiments, after the candidate list SL is generated and after the access point 1 is connected with the mobile device, the access point 1 transmits the candidate list SL to the mobile device even if the access point 1 has not received the request of the mobile device. The transceiver 20 of the access point 1 may perform channel scanning directly based on the candidate list SL to confirm whether the remote wireless access point 10A and the remote wireless access point 10C are in the vicinity of the access point 1 or within the available signal coverage. Thereafter, the processor 30 generates a neighbor list NL based on a result of the channel scanning, and when the request of the mobile device is received by the access point 1, the access point 1 may transmit the neighbor list NL as a response to the mobile device. In other words, after the access point 1 is connected to the mobile device, the access point 1 may perform channel scanning based on the candidate list SL before the request is sent by the mobile device, so as to generate the neighbor list NL.

In addition, in some embodiments, after the candidate list SL is generated and after the access point 1 is connected with the mobile device, the transceiver 20 of the access point 1 performs channel scanning based on the candidate list SL after the request of the mobile device is received by the access point 1 instead of performing channel scanning immediately based on the candidate list SL, so as to confirm whether the remote wireless access point 10A and the remote wireless access point 10C are in the vicinity of the access point 1 or within the available signal coverage. Thereafter, the processor 30 generates a neighbor list NL based on a result of the channel scanning. Then, the access point 1 may transmit the neighbor list NL to the mobile device as a response, so that the mobile device can be connected based on the candidate list SL.

Accordingly, the neighbor list NL of the present invention can provide the mobile device with information of neighbor wireless access points available for roaming. That is, the mobile device can, based on the neighbor list NL, perform channel scanning only on the remote wireless access points included in the neighbor list NL, instead of performing full-channel scanning on all the remote wireless access points. Therefore, the time and power consumed by the mobile device to perform full-channel scanning on all the access points can be effectively saved.

In addition, in some embodiments, if a plurality of remote wireless access points are included in the neighbor list NL, then these access points will be sorted in the order of strength of response signals in the channel scanning. Specifically, if the remote wireless access point 10A and the remote wireless access point 10C are included in the neighbor list NL, then the processor 30 will first determine the strength of signals responded by the remote wireless access point 10A and the remote wireless access point 10C during the channel scanning performed on the channels F1 and F3 of the remote wireless access point 10A and the remote wireless access point 10C, and then sort the remote wireless access point 10A and the remote wireless access point 10C in the order of strength of signals.

In some embodiments, the access point 1 may communicate with a remote wireless access point or a plurality of remote wireless access points in a wired manner. For example, the access point 1 may communicate with the remote wireless access point 10A, the remote wireless access point 10B and the remote wireless access point 10C in a wired manner. In addition, in the case where the access point 1 of the present invention communicates with a plurality of remote wireless access points, the number of the remote wireless access points is not limited.

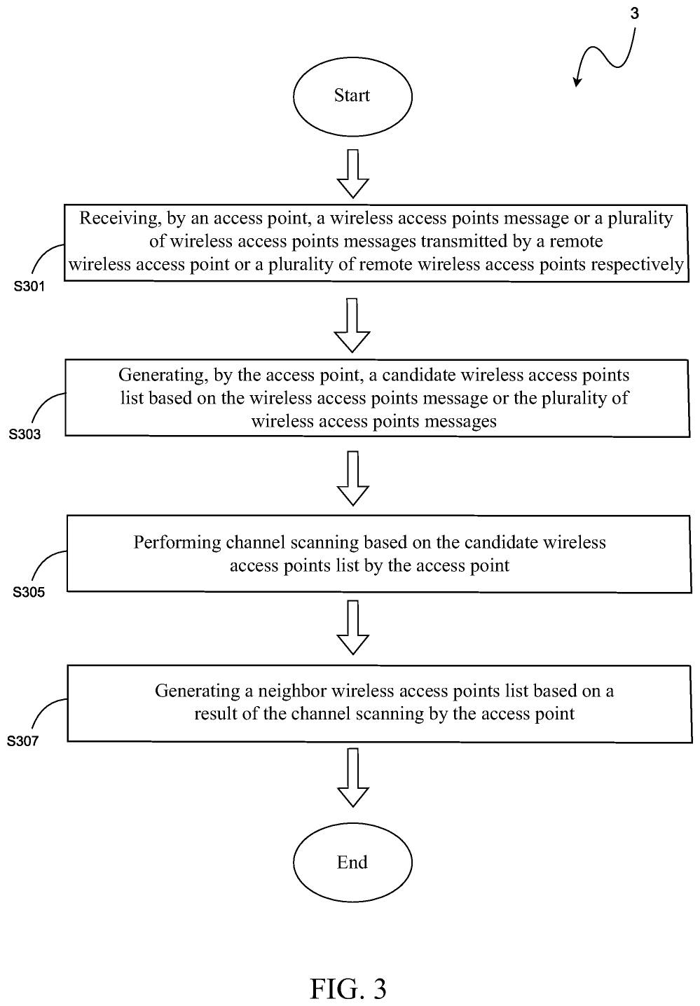

FIG. 3 illustrates a flowchart diagram of a method for establishing a neighbor wireless access points list (referred to as “a list establishing method 3” hereinafter) according to some embodiments of the present invention. The content shown in FIG. 3 is only for illustrating some embodiments of the present invention, and is not intended to limit the scope claimed in the present invention.

Referring to FIG. 3, the list establishing method 3 may include the follow steps: receiving, by an access point, a wireless access points message or a plurality of wireless access points messages transmitted by a remote wireless access point or a plurality of remote wireless access points respectively (step 301); generating, by the access point, a candidate wireless access points list based on the wireless access points message or the plurality of wireless access points messages (step 303).

In some embodiments of the list establishing method 3, the wireless access points message includes SSID information of the remote wireless access point, wireless network security setting and channel information of the remote wireless access point, and the plurality of wireless access points messages respectively include SSID information of the plurality of remote wireless access points, wireless network security settings and channel information of the plurality of remote wireless access points.

In some embodiments of the list establishing method 3, remote wireless access points included in the candidate wireless access points list have SSID information matched with the access point.

In some embodiments of the list establishing method 3, the remote wireless access points included in the candidate wireless access points list further have wireless network security settings matched with the access point.

In some embodiments of the list establishing method 3, the list establishing method 3 further comprises: performing channel scanning based on the candidate wireless access points list by the access point (step 305); and generating a neighbor wireless access points list based on a result of the channel scanning by the access point (step 307).

In some embodiments of the list establishing method 3, remote wireless access points included in the neighbor wireless access points list make a response in the channel scanning.

In some embodiments of the list establishing method 3, the remote wireless access points included in the neighbor wireless access points list are sorted in the order of strength of response signals in the channel scanning.

In some embodiments of the list establishing method 3, the list establishing method 3 further comprises: transmitting, by the access point, a wireless access points message to the remote wireless access point or the plurality of remote wireless access points.

Each embodiment of the list establishment method 3 basically corresponds to a certain embodiment of the access point 1. Therefore, all the corresponding embodiments of the access point 1 can be fully appreciated and realized by those of ordinary skill in the art simply with reference to the above description of the access point 1, even though not all the embodiments of the list establishment method 3 are described in detail above.

The above embodiments are only examples for illustrating the present invention, and are not intended to limit the scope claimed in the present invention. Any other embodiments produced by modifying, changing, adjusting and integrating the above-mentioned embodiments shall all be included in the scope claimed for the present invention as long as they are not difficult for those of ordinary skill in the art to contemplate. The scope claimed for the present invention shall be governed by the claims.

What is claimed is:

1. An access point, comprising:
a transceiver, being configured to receive a wireless access points message or a plurality of wireless access points messages transmitted by a remote wireless access point or a plurality of remote wireless access points, respectively; and
a processor electrically connected with the transceiver, being configured to generate a candidate wireless access points list based on the wireless access points message or the plurality of wireless access points messages.

2. The access point according to claim 1, wherein the wireless access points message includes Service Set Identifier (SSID) information of the remote wireless access point, wireless network security setting and wireless channel information of the remote wireless access point, and the plurality of wireless access points messages respectively include SSID information of the plurality of remote wireless access points, wireless network security settings and wireless channel information of the plurality of remote wireless access points.

3. The access point according to claim 2, wherein the remote wireless access points included in the candidate wireless access points list have SSID information matched with the wireless access point.

4. The access point according to claim 3, wherein the remote wireless access points included in the candidate wireless access points list further have wireless network security settings matched with the access point.

5. The access point according to claim 1, wherein the transceiver is further configured to perform channel scanning based on the candidate wireless access points list, and the processor is further configured to generate a neighbor wireless access points list based on a result of the channel scanning.

6. The access point according to claim 5, wherein remote wireless access points included in the neighbor wireless access points list make a response in the channel scanning.

7. The access point according to claim 6, wherein the remote wireless access points included in the neighbor wireless access points list are sorted in the order of strength of response signals in the channel scanning.

8. The access point according to claim 1, wherein the transceiver is further configured to transmit a wireless access points message to the remote wireless access point or the plurality of remote wireless access points.

9. The access point according to claim 1, wherein the transceiver is further configured to transmit the candidate wireless access points list to a mobile device and perform channel scanning based on the candidate wireless access points list, and the processor is further configured to generate a neighbor wireless access points list based on a result of the channel scanning.

10. The access point according to claim 1, wherein after a request sent by a mobile device is received by the access point, the transceiver is further configured to perform channel scanning based on the candidate wireless access points list, and the processor is further configured to generate a neighbor wireless access points list based on a result of the channel scanning.

11. The access point according to claim 1, wherein the transceiver is further configured to transmit the candidate wireless access points list to a mobile device while a request sent by the mobile device is received by the access point, and the transceiver performs channel scanning based on the candidate wireless access points list, and the processor is further configured to generate a neighbor wireless access points list based on a result of the channel scanning.

12. A method for establishing a candidate wireless access points list, comprising:
receiving, by an access point, a wireless access points message or a plurality of wireless access points messages transmitted by a remote wireless access point or a plurality of remote wireless access points respectively; and
generating, by the access point, a candidate wireless access points list based on the wireless access points message or the plurality of wireless access points messages.

13. The method for establishing the candidate wireless access points list according to claim 12, wherein the wireless access points message includes SSID information of the remote wireless access point, wireless network security setting and wireless channel information of the remote wireless access point, and the plurality of wireless access points messages respectively include SSID information of the plurality of remote wireless access points, basic SSID, wireless network security settings and wireless channel information of the plurality of remote wireless access points.

14. The method for establishing the candidate wireless access points list according to claim 13, wherein remote wireless access points included in the candidate wireless access points list have SSID information matched with the access point.

15. The method for establishing the candidate wireless access points list according to claim 14, wherein the remote wireless access points included in the candidate wireless access points list further have wireless network security settings matched with the access point.

16. The method for establishing the candidate wireless access points list according to claim 12, further comprising: performing channel scanning based on the candidate wireless access points list and generating a neighbor wireless access points list based on a result of the channel scanning by the access point.

17. The method for establishing the candidate wireless access points list according to claim 16, wherein the remote wireless access points included in the neighbor wireless access points list make a response in the channel scanning.

18. The method for establishing the candidate wireless access points list according to claim 17, wherein the remote wireless access points included in the neighbor wireless access points list are sorted in the order of strength of response signals in the channel scanning.

19. The method for establishing the candidate wireless access points list according to claim 12, further comprising: transmitting, by the access point, a wireless access points message to the remote wireless access point or the plurality of remote wireless access points.

20. The method for establishing the candidate wireless access points list according to claim 12, further comprising: transmitting, by the access point, the candidate wireless access points list to a mobile device and performing channel scanning based on the candidate wireless access points list and generating a neighbor wireless access points list based on a result of the channel scanning.

21. The method for establishing the candidate wireless access points list according to claim 12, further comprising: performing channel scanning based on the candidate wireless access points list after a request sent by a mobile device is received by the access point and generating a neighbor wireless access points list based on a result of the channel scanning by the access point.

22. The method for establishing the candidate wireless access points list according to claim 12, further comprising: transmitting the candidate wireless access points list to a mobile device by the access point while a request sent by the mobile device is received, and performing channel scanning based on the candidate wireless access points list and generating a neighbor wireless access points list based on a result of the channel scanning by the access point.
